(19) United States
(12) Patent Application Publication
(10) Pub. No.: US 2012/0026847 A1
(43) Pub. Date: Feb. 2, 2012

(54) Optical Device, Manufacturing Method Thereof, Optically Assisted Magnetic Recording Head and Magnetic Recorder

(75) Inventors: Hiroyuki SHINDO, Tokyo (JP); Hiroshi Hatano, Osaka (JP); Mitsuru Yokoyama, Osaka (JP)

(73) Assignee: Konica Minolta Opto, Inc., Tokyo (JP)

(21) Appl. No.: 13/195,704

(22) Filed: Aug. 1, 2011

(30) Foreign Application Priority Data
Jul. 30, 2010 (JP) 2010-171449
Nov. 29, 2010 (JP) 2010-264704

(51) Int. Cl. G11B 11/00; C23F 1/00; B29D 11/00; G02B 5/10

(52) U.S. Cl. 369/13.33; 359/867; 216/24; 264/1.1; G9B/11

(57) ABSTRACT

Disclosed is an optical device including a concave surface formed of a part of a cylindrically curved surface, and the concave surface is a reflection surface.

### BACKGROUND OF THE INVENTION

1. Field of the Invention

The present invention relates to an optical device which couples the light from a light source with a planar waveguide, a manufacturing method for manufacturing the optical device, an optically assisted magnetic recording head using the optical device and a magnetic recorder.

2. Description of Related Art

As a method for increasing the magnetic recording density of a hard disk drive, the optically assisted method is being actively studied. In the optically assisted method, magnetic recording is carried out by reducing the coercivity of a recording layer by heating a medium by a heat of an optical spot and controlling in an magnetic domain direction according to recoding information by an external magnetic field.

Therefore, in view of increasing the recording density, the key point is how the optical spot for heating the medium can be made minute.

With respect to making the optical spot be minute, the trend is settling to use the technology of near field light by which a spot size of a few tens of nanometers can be realized.

As a method to generate a near field light, the method to generate a near field light from a plasmon probe by irradiating the light from a light source to a plasmon probe via a waveguide is becoming the mainstream. In particular, a waveguide is laminated on a slider provided at a head with a magnetic recording and reproducing unit (magnetic head unit) by a semiconductor process and a plasmon probe is formed near the exit end on the medium side of the waveguide to generate a near field light by irradiating the light from a light source to the plasmon probe via the waveguide.

In such method of generating a near field light, structuring of a coupling optical system to couple the light from a light source with the wave guide is a problem.

The coupling optical system arranged on a slider which biases and focuses the light emitted from a semiconductor laser and couples the light with the waveguide is suggested as one of the coupling optical system (for example, see JP 2003-45004).

FIG. 19 is a schematic view of an optically assisted magnetic recording head described in JP 2003-45004.

The optically assisted magnetic recording head described in JP 2003-45004 includes a semiconductor laser 50, a slider 55, a coupling optical system 54 and a waveguide 56.

The semiconductor laser 50 includes a substrate 52 and a laminated unit 53, and is mounted on the slider 55. An active layer 51 emits laser beam.

As the coupling optical system 54, an aspheric mirror as a two dimensional focusing device which reflects and focuses the laser beam which is emitted from the end surface of the active layer 51 and couples the beam with the waveguide 56 is described.

Here, because the active layer 51 produces heat when emitting light, it is preferable that the laminated unit 53 contacts the slider for the purpose of releasing heat to the slider. In such case, the optic axis of the laser beam emitted from the end surface of the active layer 51 be near the surface of the slider on which the semiconductor laser is mounted being within a few micrometers thereof.

In the coupling optical system 54 described in JP 2003-45004, the aspheric mirror which is the coupling optical system is formed of glass, and the light from the incident surface is made to transmit inside thereof and the light is subjected to an internal reflection by the aspheric mirror on which a reflection film is formed and is focused to be emitted from the exit surface. Therefore, the distance from the intersection of the optic axis and the aspheric mirror to the incident end of the waveguide (focus point) equals the distance from the center of the active layer to the surface of the slider on which the semiconductor laser is mounted. Thus, the size of the aspheric mirror is extremely small such as a few micrometers to a few tens of micrometers, and manufacturing of such aspheric mirror is difficult.

Further, the spot to where the light from a light source is irradiated and focused needs to match the incident end of the waveguide 56. The width of the incident end of the waveguide 56 is very small such as a few micrometers and it is very difficult to adjust relative positions of the optical spot and the incident end, and a great number of procedures need to be carried out to meet the requirement of carrying out such adjustment in two directions orthogonal to each other.

Moreover, the aspheric mirror includes three surfaces which are incident surface, reflection surface and exit surface, and great amount of light is lost. For example, even when it is assumed that transmittance rate through the incident surface and the exit surface is 99% and the reflection rate at the reflection surface is 99%, the amount of light loss through the three surfaces accumulates to 3%. When the amount of light loss is to be compensated by increasing the amount of light to be emitted from a light source, new problems such as increase in power consumption at the light source and increase in heat production arise.

### SUMMARY OF THE INVENTION

In view of the above problems, an object of the present invention is to provide an optical device in which the amount of light loss is small and which can be manufactured easily, a manufacturing method for mass producing the optical devices with good reproducibility regardless of materials, an optically assisted magnetic recording head using the optical device in which power consumption is small and which is easy to assemble and a magnetic recorder using the optically assisted magnetic recording head in which power consumption is small and which is easy to manufacture.

The above objects can be achieved by the invention described below.

According to a first aspect of the present invention, an optical device includes a concave surface formed of a part of a cylindrically curved surface, and the concave surface is a reflection surface.

Preferably, the concave surface is formed of a part of a circular-cylindrically curved surface.

Preferably, the concave surface is formed of a part of an approximately oval-cylindrically curved surface.

Preferably, a reflection film is formed on the concave surface.

According to a second aspect of the present invention, in a manufacturing method of the optical device of the present invention, the concave surface is transferred by a mold having a reverse shape of the concave surface.

According to a third aspect of the present invention, in a manufacturing method of the optical device of the present invention, the optical device is formed based on a plate-like substrate, and the concave surface is formed by directly processing the substrate.

Preferably, the directly processing includes a dicing or an etching.

According to a fourth aspect of the present invention, in a manufacturing method of the optical device of the present invention, the manufacturing method includes a drawing of a base material in an axis direction, the base material having a shape similar to a shape of the optical device when the optical device is seen from a direction along the axis direction of the cylindrically curved surface.

According to a fifth aspect of the present invention, an optical device is manufactured by the manufacturing method of the present invention.

According to a sixth aspect of the present invention, an optically assisted magnetic recording head includes a light source, a waveguide which irradiates light emitted from the light source on a magnetic recording medium and a slider which mounts the light source and the waveguide, and the light emitted from the light source is reflected and coupled with the waveguide by using the optical device of the present invention.

Preferably, the optically assisted magnetic recording head of the present invention further includes a holding unit to hold the light source, the holding unit being disposed between the light source and the slider.

Preferably, the holding unit further holds the optical device.

According to a seventh aspect of the present invention, a magnetic recorder has the optically assisted magnetic recording head of the present invention mounted thereto.

According to the present invention, an optical device in which the amount of light loss is small and which can be manufactured easily, a manufacturing method for mass producing the optical devices with good reproducibility regardless of materials, an optically assisted magnetic recording head using the optical device in which power consumption is small and which is easy to assemble and a magnetic recorder using the optically assisted magnetic recording head in which power consumption is small and which is easy to manufacture can be provided.

### BRIEF DESCRIPTION OF THE DRAWINGS

The present invention will become more fully understood from the detailed description given hereinbelow and the appended drawings which are given by way of illustration only, and thus are not intended as a definition of the limits of the present invention, and wherein:

FIG. 1 is a schematic view showing an example of outline structure of an optically assisted magnetic recording device;

FIG. 2 is an outlined cross sectional view of an optically assisted magnetic recording head;

FIG. 3 is a schematic view of an one dimensional focusing optical device 9B;

FIG. 4 is a diagram for explaining an operation of a reflection surface 13 in a case where the reflection surface 13 of the one dimensional focusing optical device 9B is a cylindrical surface formed of a part of an approximately oval figure ;

FIG. 5 is a schematic view showing that the approximately oval surface corresponds to the reflection surface 13 of the one dimensional focusing optical device 9B;

FIG. 6 is a specific example of a planar waveguide 8a which includes a planar solid immersion mirror (PSIM) having a mirror type focusing function;

FIG. 7 is a specific example of a planar waveguide 8b having a tapered type focusing function;

FIG. 8 is a schematic view of the planar waveguide 8a of the optically assisted magnetic recording head 3 when seen from the y direction;

FIG. 9 is an example of a core 20 which is a main part of a mold which can be used in injection molding, glass molding or imprinting;

FIG. 10A is a schematic view showing an example of a manufacturing process of the one dimensional focusing optical device 9B;

FIG. 10B is a schematic view showing the example of the manufacturing process of the one dimensional focusing optical device 9B;

FIG. 10C is a schematic view showing the example of the manufacturing process of the one dimensional focusing optical device 9B;

FIG. 10D is a schematic view showing the example of the manufacturing process of the one dimensional focusing optical device 9B;

FIG. 11A is a schematic view of a photolithography processing method;

FIG. 11B is a schematic view of the photolithography processing method;

FIG. 11C is a schematic view of the photolithography processing method;

FIG. 11D is a schematic view of the photolithography processing method;

FIG. 11E is a schematic view of the photolithography processing method;

FIG. 11F is a schematic view of the photolithography processing method;

FIG. 12A is a schematic view of a manufacturing method of a gray scale mask 34 using a photolithography processing method;

FIG. 12B is a schematic view of the manufacturing method of the gray scale mask 34 using the photolithography processing method;

FIG. 12C is a schematic view of the manufacturing method of the gray scale mask 34 using the photolithography processing;

FIG. 12D is a schematic view of the manufacturing method of the gray scale mask 34 using the photolithography processing;

FIG. 13A is a schematic view of a photolithography processing method wherein etching is the main process thereof;

FIG. 13B is a schematic view of the photolithography processing method wherein etching is the main process thereof;

FIG. 13C is a schematic view of the photolithography processing method wherein etching is the main process thereof;

FIG. 13D is a schematic view of the photolithography processing method wherein etching is the main process thereof;

FIG. 13E is a schematic view of the photolithography processing method wherein etching is the main process thereof;

FIG. 13F is a schematic view of the photolithography processing method wherein etching is the main process thereof;

FIG. 13G is a schematic view of the photolithography processing method wherein etching is the main process thereof;

FIG. 13H is a schematic view of the photolithography processing method wherein etching is the main process thereof;

FIG. 13I is a schematic view of the photolithography processing method wherein etching is the main process thereof;

FIG. 13J is a schematic view of the photolithography processing method wherein etching is the main process thereof;

FIG. 14A is a schematic view of a processing using a dicing blade 81;

FIG. 14B is a schematic view of the processing using the dicing blade 81;

FIG. 14C is a schematic view of the processing using the dicing blade 81;

FIG. 14D is a schematic view of the processing using the dicing blade 81;

FIG. 15A is a schematic view of a processing carried out to a tip portion of the dicing blade 81;

FIG. 15B is a schematic view of the processing carried out to the tip portion of the dicing blade 81;

FIG. 15C is a schematic view of the processing carried out to the tip portion of the dicing blade 81;

FIG. 16 is a schematic view of a drawing process;

FIG. 17 is a schematic view where a unit substrate 60 is provided as a unit for holding the light source 9A;

FIG. 18A is an outline view of the one dimensional focusing optical device 9B in which the reflection surface 13 of a cylindrical surface is formed in a rectangular solid;

FIG. 18B is an outline view of the one dimensional focusing optical device 9B in which the reflection surface 13 of a cylindrical surface is formed in a rectangular solid; and

FIG. 19 is a schematic view of an optically assisted magnetic recording head described in JP 2003-45004.

### DESCRIPTION OF THE PREFERRED EMBODIMENTS

Hereinafter, the optical device of the present invention, the optically assisted magnetic recording head and the magnetic recorder and the like which are provide with the optical device of the present invention will be described with reference to the drawings. Here, same symbols are used for the same parts and corresponding parts among the embodiments and the specific examples, and the descriptions which overlap are arbitrarily omitted.

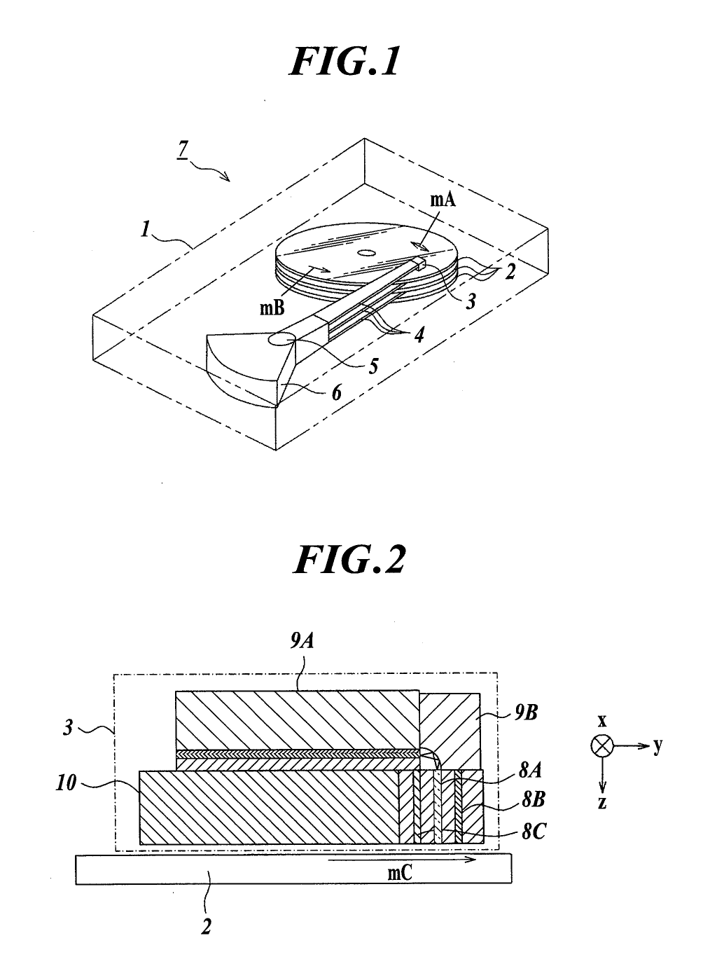

In FIG. 1, an example of outline structure of the magnetic recorder 7 (for example, a hard disk drive) in which the optically assisted magnetic recording head 3 is mounted is shown. The magnetic recorder 7 includes a recoding disk 2 (magnetic recording medium), a suspension 4 which is provided so as to rotate in the direction of an arrow mA (tracking direction) by having the spindle 5 as a supporting point, an actuator 6 for tracking which is attached to the suspension 4, an optically assisted magnetic recording head 3 which is attached at a tip portion of the suspension 4 and a motor (not shown in the drawing) which rotates the disk 2 in the direction of an arrow mB, all of which are housed in a case 1. Further, the magnetic recorder 7 is structured so that the optically assisted magnetic recording head 3 moves relatively while levitating above the disk 2 (the disk 2 moves in the direction of an arrow mC in FIG. 2).

In FIG. 2, an example of outline structure of the optically assisted magnetic recording head 3 is shown as a cross section diagram. The optically assisted magnetic recording head 3 is a micro optical recording head which uses light for recording information on the disk 2, and the optically assisted magnetic recording head 3 includes a light source 9A, a slider 10, a one dimensional focusing optical device 9B and the like.

The light source 9A includes a semiconductor laser. The light source 9A may be a combination of a semiconductor laser and an optical component such as an optical fiber, an optical waveguide, a collimate lens or the like. Preferably, the wave length of the laser beam which is to be emitted from the semiconductor laser constituting the light source 9A is the wave length between visible light and near infrared (wave length zone between about 0.6 μm and 2 μm, and in particular, a wave length of 650 nm, 780 nm, 830 nm, 1310 nm, 1550 nm and the like are suggested).

The slider 10 is constituted of a substrate formed with AlTiC material, and a magnetic reproducing unit 8C, an optical assisting unit 8A and a magnetic recording unit 8B are formed in a laminated condition on the surface of the substrate in this order from the input side to the output side of the to-be recorded part of the disk 2 (in the direction of an arrow mC). Here, the order is not limited to the above order as long as the optical assisting unit 8A is disposed more to the input side than the magnetic recording unit 8B.

The magnetic recording unit 8B is formed of a magnetic recording device which writes magnetic information to the to-be recorded part of the disk 2, and the magnetic reproducing unit 8C is formed of a magnetic reproducing device which reads magnetic information recording in the disk 2. Here, the optical assisting unit 8A, the magnetic recoding unit 8B and the magnetic reproducing unit 8C are integrally formed with the slider 10. However, the optical assisting unit 8A, the magnetic recoding unit 8B and the magnetic reproducing unit 8C which are individually structured may be attached to the slider 10.

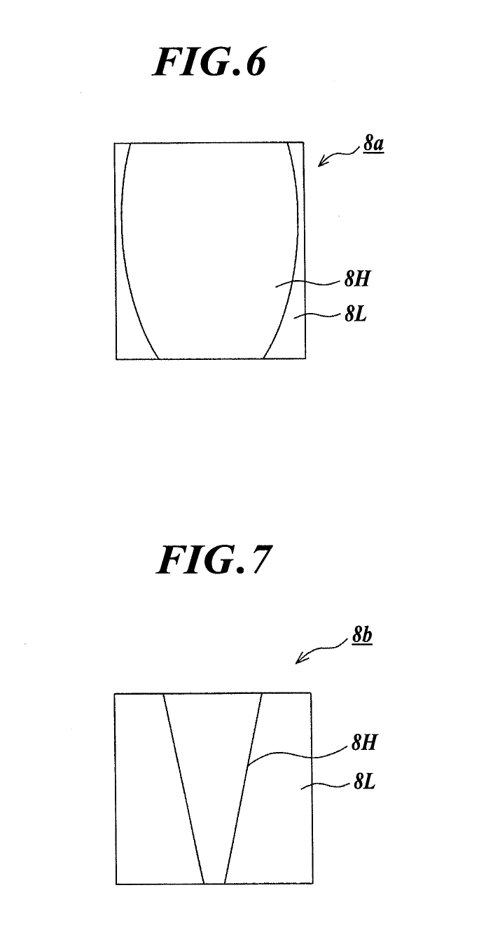

The optical assisting unit 8A is constituted of the after-mentioned planar waveguide (see FIGS. 6 and 7) and the plasmon probe (not shown in the drawing). The planar waveguide focuses the laser beam from the light source toward the emission end surface on the disk 2 side and irradiates the focused laser beam to the plasmon probe. The plasmon probe generates a near field light for spot heating the to-be recorded part of the disk 2.

The one dimensional focusing optical device 9B which is the optical device of the present invention is a biasing optical device which biases the incident light which is spread out and focuses the light only in one direction by having a reflection mirror which is the reflection surface 13 of a cylindrically concaved surface.

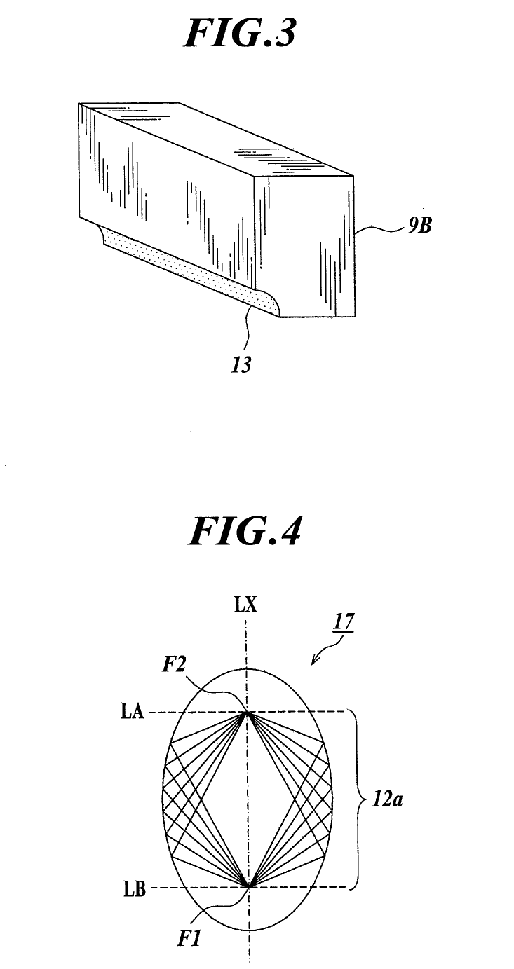

In FIG. 3, a schematic view of the one dimensional focusing optical device 9B is shown. The one dimensional optical device 9B is formed in a shape where the reflection surface 13 of a circular-cylindrical surface is formed in a part of an edge line of a rod-like rectangular solid. The reflection surface 13 is exposed and functions as a surface reflection mirror. The reflection mirror can be formed of a metal film such as gold, aluminium and the like, a reflection film of a dielectric multi layered film, or the like. Because it is a surface reflection mirror, there is no incident surface or exit surface and the amount of light loss can be reduced. Because the reflection surface 13 is a concaved circular-cylindrical surface, the focusing function is manifested only in the direction having a curvature. Because the focusing function is one dimensional, the focused light is linear and the strict positional adjustment of the light on the incident end surface of the planar waveguide which couples light only needs to be carried out in one dimensional direction. Therefore, the positional adjustment is much easier comparing to a case where light is focused in two dimensional directions. Because the reflection surface 13 of a circular-cylindrical surface which is the surface reflection face is formed in a part of the edge line of the rod-like rectangular solid, the reflection surface 13 can be made easily even when it is an extremely small mirror because the rectangular solid itself can be made in relatively large size. Further, the handling ability of the optical device can be maintained and the optically assisted magnetic recording head can be assembled easily. Here, shape of the curved surface of the one dimensional focusing optical device is not limited to a circular shape, and can be a cylindrical surface formed of a part of a section of aspheric surface such as an oval surface. The one dimensional focusing optical device 9B will be described in detail later.

The laser beam which is emitted from the light source 9A is guided to the optical assisting unit 8A by the one dimensional focusing optical device 9B. The laser beam which entered the optical assisting unit 8A passes through the planar waveguide in the optical assisting unit 8A and exists from the optically assisted magnetic recording head 3.

When the laser beam which exits from the optical assisting unit 8A is irradiated to the disk 2 as a micro optical spot, the temperature at the to-be irradiated portion of the disk 2 increases temporarily and the coercivity of the disk 2 is reduced. Magnetic information is to be written to the to-be irradiated portion which is in a state where the coercivity is reduced by the magnetic recording unit 8B.

The coupling efficiency of the coupling optical system which is mounted in the one dimensional focusing optical device 9B shown in FIG. 3 will be described by using a string of numerical values. The radius of curvature of the reflection surface 13 is set to 20 μm, the distance of the optic axis from the exit end of the light source (semiconductor laser) 9A to the reflection surface 13 is set to 14.13 μm, the distance of the optic axis from the reflection surface 13 to the image surface (focusing surface) is set to 15.36 μm, the mode field diameters of the planar waveguide in x and y directions shown in FIG. 2 are respectively set to 5 μm and 1 μm, the wave length of the light source (semiconductor laser) 9A is set to 0.785 μm, and the emission angle (full width at half maximum) is set to 9.5° in x direction and 23° in z direction (y direction after biased). When the intensity distribution of laser beam is the Gaussian distribution, the coupling efficiency with the planar waveguide is 60.5% and a sufficient coupling efficiency can be obtained for an optically assisted method. Because the intensity distribution of laser beam which is emitted from the light source (semiconductor laser) 9A forms an oval in z direction, a sufficient coupling efficiency can be obtained only by focusing in this direction. Here, “Basics and application of optical coupling system for optical device” (by Kenji Kono, Gendaikogaku-sha) is referred to for calculation methods.

FIG. 4 is a diagram for explaining the operation of the reflection surface 13 in a case where the reflection surface 13 of the one dimensional focusing optical device 9B is a cylindrical surface formed of a part of an approximately oval figure. The symbol 17 indicates an approximately oval surface and the reflection surface 13 has a shape which is a part of the approximately oval surface.

Because the optical operation is limited to only one direction in the one dimensional focusing optical device 9B, “approximately oval surface” means a cylindrical oval surface having power only in one direction throughout the present specification.

In the approximately oval surface 17 shown in FIG. 4, two straight lines LA and LB which are perpendicular to the longitudinal axis LX of the oval shape are respectively disposed on two focus points F2 and F1. One of the curved reflection surfaces 12a divided by the portion of LX which is between the straight lines LA and LB corresponds to the reflection surface 13.

Therefore, all of the laser beam which is emitted from one focus point F2 (emission end surface of the light source 9A) and focused by being reflected at the curved reflection surface 12a forms an optical spot when reaching the other focus point F1 (incident end of the planar waveguide). In such way, by setting the incident position and the focusing position of the laser beam be the positions of two focus points F1 and F2 of the approximately oval surface 17, the generation of aberration in the focusing direction can be reduced and the coupling efficiency with the planar waveguide can be enhanced more comparing to the reflection surface 13 of a cylindrical surface. For example, in the string of numerical values of the reflection surface 13, when the conic constant 1.00053 is included to be an approximately oval surface and when the distance of the optical axis from the reflection surface 13 to the best image surface (focusing surface) in the approximately oval surface is 14.15 μm, the coupling efficiency is 70.6% and the coupling efficiency can be enhanced for about 1.2 times that of a cylindrical surface.

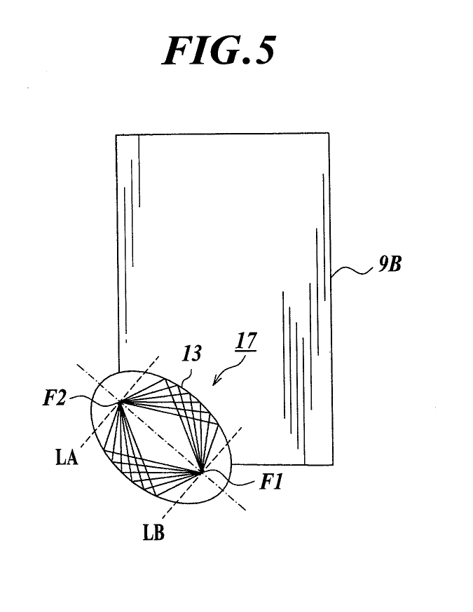

FIG. 5 is a schematic view showing that the reflection surface 13 in the one dimensional focusing optical device 9B corresponds to the approximately oval surface 17.

As described above, when the one dimensional focusing optical device 9B is provided for making the laser beam which is emitted from the light source 9A enter the planar waveguide, the coupling efficiency with respect to the planar waveguide can be enhanced drastically due to biasing and focusing of the laser beam by being reflected at the curved reflection surface 12a. Further, the coupling is possible with no aberration with respect to the focusing direction, therefore, even higher light use efficiency can be obtained.

Next, in FIGS. 6 and 7, specific examples of the planar waveguide having the optical assisting unit 8A are shown. FIG. 6 is a specific example of the planar waveguide 8a including the planar solid immersion mirror (PSIM) having a mirror type focusing function. FIG. 7 is a specific example of the planar waveguide 8b having a tapered type focusing function. The waveguide structure used in such planar waveguides 8a and 8b is constituted by laminating a high refraction layer 8H on a substrate and laminating a low refraction layer 8L around the high refraction layer 8H, and laser beam is focused by the reflection operation at the interface between the high refraction layer 8H and the low refraction layer 8L.

In the planar waveguide 8a shown in FIG. 6, the interface between the high refraction layer 8H and the low refraction layer 8L forms a part of the approximately oval surface.

At the interface between the high refraction layer 8H and the low refraction layer 8L shown in FIG. 6, total reflection occurs due to the refraction difference. Because the interface forms a part of the approximately oval surface, a source image is formed at the focus position on the approximately oval surface when spread-out light enters the planar waveguide 8a. That is, laser beam is focused in one direction by a mirror effect using the total reflection in the planar waveguide 8a to form a micro optical spot.

In the planar waveguide 8b shown in FIG. 7, the interface between the high refraction layer 8H and the low refraction layer 8L is formed in straight lines. Two interfaces are formed in the planar waveguide 8b and the laser beam which entered the high refraction layer 8H is totally reflected repeatedly between the two interfaces and the mode field diameter becomes smaller gradually as proceed toward the exit end. Further, the laser beam is focused at the exit end of the high refraction layer 8H and a micro optical spot can be formed.

As described above, when the planar waveguide 8a or 8b is used for the optical assisting unit 8A, a micro optical spot can be obtained. Therefore, light having high energy density can be irradiated to the plasmon probe and light quantity of near field light generation can be increased.

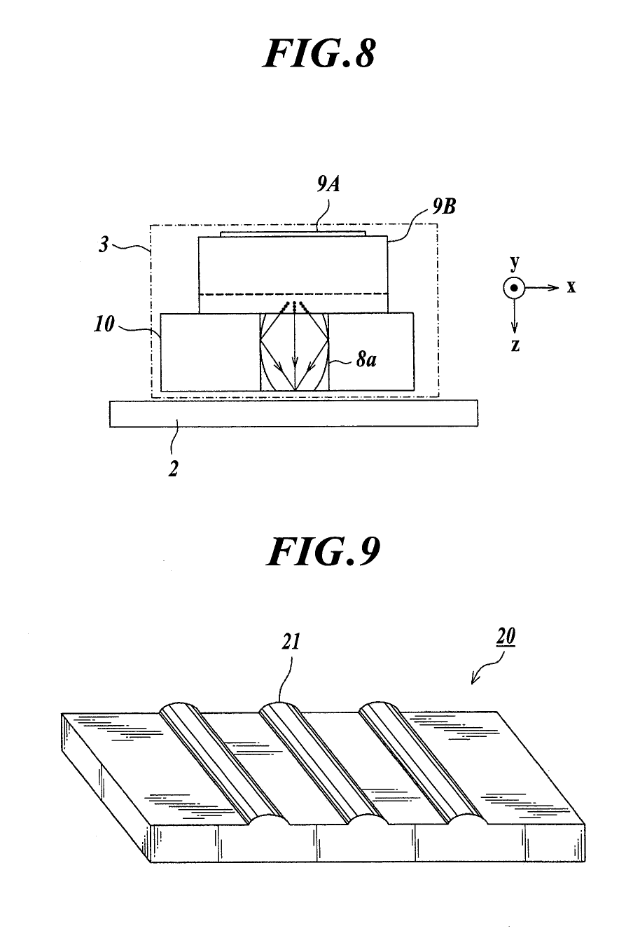

In the optically assisted magnetic recording head 3 shown in FIG. 2, the one dimensional focusing optical device 9B optically couples the light source 9A and the planar waveguide 8a or 8b (FIGS. 6 and 7) inside of the optical assisting unit 8A and biases the laser beam which is emitted from the light source 9A to make the laser beam enter the planar waveguide 8a or 8b. FIG. 8 is a schematic view when the planar waveguide 8a of the optically assisted magnetic recording head 3 is seen from the y direction. The laser beam which is coupled with the planar waveguide 8a from the light source 9A is focused by the planar waveguide 8a so as to generate a near field light on the disk 2.

In a magnetic recorder in which the above described optically assisted magnetic recording head 3 is mounted, the optic axis in y direction of the light which is emitted from the semiconductor laser is returned for 90° in y-z surface at the reflection surface of the biasing optical device and is biased in z direction and focused in the y-z surface to enter the planar waveguide. On the other hand, the light in x direction enters the waveguide in a spread out state without being focused and the x direction of the light is focused in the waveguide having the approximately oval reflection surface shown in FIG. 6, for example. At the exit end of the waveguide, light is sufficiently focused in x direction and y direction and irradiates the plasmon probe (not shown in the drawing) which is formed at the exit end surface of the waveguide to generate a near field light from the plasmon probe. The disk 2 is heated by the near field light and the coercivity thereof is reduced and magnetic information is recorded at the magnetic recording unit 8B. Then, the disk 2 moves from the optically assisted magnetic recording head 3 and the coercivity thereof recovers when cooled down and the magnetic information is retained.

Therefore, a micro optical spot can be obtained with high light use efficiency without requiring a highly precise positional adjustment. Further, a dense information recording can be carried out by using such optical spot.

### (Manufacturing Method of the One Dimensional Focusing Optical Device)

### [First Manufacturing Method]

For example, the one dimensional focusing optical device 9B is made by injection molding, glass molding or imprinting. As for the resin for the injection molding, polycarbonate which is a thermoplastic resin (for example, AD5503 manufactured by TEIJIN CHEMICALS LTD.) or non-transparent resin may be used. As for the resin for the imprinting, PAK-02 (manufactured by Toyo Gosei Co., Ltd) which is a photocurable resin is suggested as an example.

FIG. 9 is an example of a core 20 which is the main part of a mold which can be used in injection molding, glass molding or imprinting. On the core 20, approximately oval curved surfaces 21 corresponding to the reflection surfaces 13 are formed. That is, the reflection surfaces 13 are transferred and formed by the core 20 which is a mold having a reverse shape of the reflection surface 13 which is a concaved surface. The core 20 is made by machining a metal.

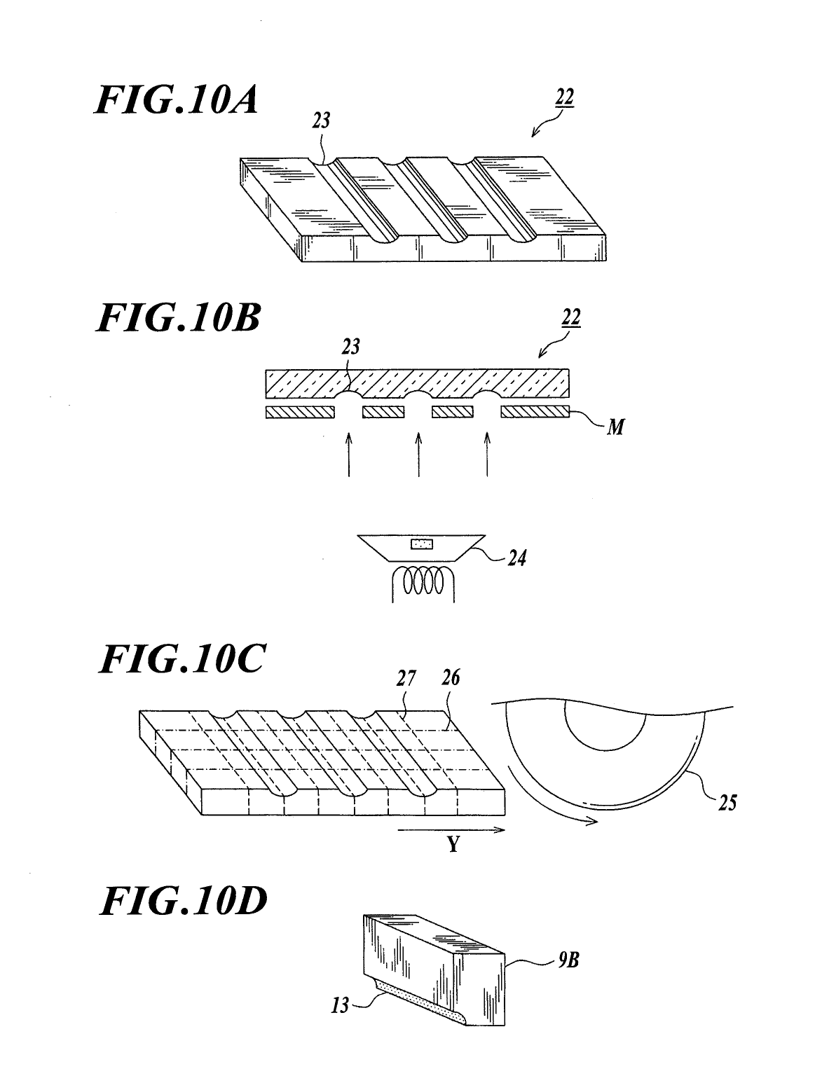

FIGS. 10A to 10D are schematic views showing an example of a manufacturing process of the one dimensional focusing optical device 9B. FIG. 10A is an example of a plate like molded product 22 made by injection molding by using the core 20. When the core 20 is the positive shape, the molded product 22 having concaved surfaces which is the negative shape is obtained. The curved surfaces 23 are formed as concaved surfaces each of which is a curved surface in which two reflection surfaces 13 of the one dimensional focusing optical device 9B are arranged facing each other.

FIG. 10B is a schematic view showing a method for forming a reflection film on the curved surfaces 23 of the molded product 22. Vacuum thin film coating methods such as a vapor deposition method, a spattering method or the like is used for forming the reflection film. FIG. 10B is an example using a heating evaporation method. The evaporation source 24 is heated by high frequency wave or the like and evaporated metal is to be formed as a film through a mask M which allows to select the curved surfaces 23. Here, the film may be formed on the entire surface on which the curved surfaces 23 are formed without using the mask M.

FIG. 10C is a schematic view showing how the molded product 22 is cut into the shapes of the one dimensional focusing optical device 9B by using the dicing saw (not shown in the drawing).

The dicing blade 25 rotates at high speed and cuts the molded product 22 along the cut lines 26 by moving the molded product 22 by using the automatic moving stage. Further, after the molded product 22 is rotated for 90°, the molded product 22 is cut along the cut lines 27. A part of the cut lines 27 correspond to the center of the curved surfaces 23.

FIG. 10D shows the one dimensional focusing optical device 9B which is made by being cut as described above. As described above, the one dimensional focusing optical device 9B can be made by injection molding. Here, when using glass molding or imprinting, the molded product 22 can be obtained by making a core similar to the core 20. The method to obtain individual one dimensional focusing optical device 9B from the obtained molded product 22 is similar to the method as described above.

### [Second Manufacturing Method]

The one dimensional focusing optical device 9B can be made by directly processing the glass substrate or a silicon substrate by using a photolithography processing method.

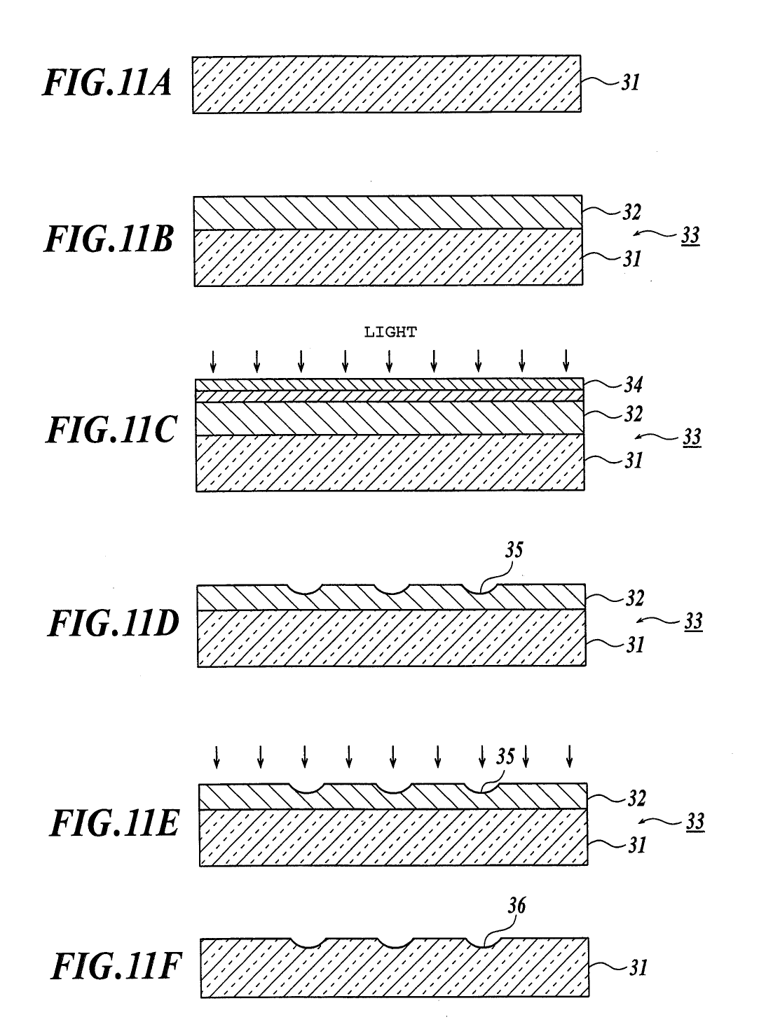

FIGS. 11A to 11F are schematic views of the photolithography processing method. Hereinafter, a manufacturing method of the one dimensional focusing optical device 9B will be described by using FIGS. 11A to 11F.

First, a glass substrate 31 is prepared (see FIG. 11A). Because dry etching is to be carried out in the later procedure, therefore, it is preferred that the glass is of a material such as silica glass which includes very small amount of impurities. Further, it is preferred that the glass is cleansed in a volatile solvent such as a neutral detergent, an acetone or the like by using an ultrasonic cleaner.

Next, a negative type photo resist is formed on the glass substrate 31 by using a spinner or a roll coater and a resist substrate 33 where the photo resist layer 32 is formed is made (see FIG. 11B). The thickness of the photo resist layer 32 is decided by how much the glass substrate 31 is to be etched and the etching speed of the photo resist layer 32 and the glass substrate 31. After the forming of the film, the solvent is evaporated by baking. Here, a dip coating may be carried out.

Next, by using the gray scale mask 34, the photo resist layer 32 is exposed to light by having the gray scale mask 34 being adhered to the photo resist layer 32 to print a pattern on the photo resist layer 32 (see FIG. 11C). The gray scale mask 34 is a photo mask having distribution of light transmittance. In the gray scale mask 34 which is to be used in the embodiment, the part having high transmittance and the part having low transmittance are distributed periodically. When exposure to light is to be carried out by having the mask being adhered, an aligner which is not shown in the drawing is used. Here, the light exposure may be carried out by using a stepper. The manufacturing method of the gray scale mask 34 will be described later. After the light exposure by having the mask being adhered, wet etching is carried out to the photo resist layer 32 by dipping the substrate into an alkaline solution. By carrying out the wet etching, the photo resist layer 32 is etched for an etching amount which is inversely proportionate to the total amount of light energy which transmitted through the gray scale mask 34. Therefore, by making the distribution of transmittance of the gray scale mask 34 be in a circular-cylindrical surface shape, a curved surface 35 of a circular-cylindrical surface can be obtained (see FIG. 11D).

Next, anisotropic etching is carried out to the resist substrate 33 to which the light exposure with a mask is carried out by dry etching from the opposite side of the glass substrate 31 which is the surface normal direction of the photo resist layer (see FIG. 11E). Anisotropic etching means to carry out etching in one direction. Dry etching is a method of etching the material by a reactive gas (etching gas), ions or radicals. To carry out anisotropic etching by dry etching, it is preferred to use the RIE (Reactive Ion Etching) device.

In such way, when anisotropic etching is carried out from the opposite side of the glass substrate 31 which is the surface normal direction of the photo resist layer 32, etching is started from the photo resist layer 32 and the etching operation reaches to the glass substrate 31 (see FIG. 11F). Because the curved surfaces 35 of a circular-cylindrical surface are formed in the photo resist layer 32, the curved surfaces 36 of a circular-cylindrical surface are to be formed on the surface on the photo resist layer 32 side of the glass substrate 31. Here, the shape of the curved surface 36 is a shape where the etching speed ratio of the photo resist layer 32 and the glass substrate 31 is multiplied with the depth of the curved surface 35. Therefore, by selecting the type of the resist and the material of the glass substrate so that the etching speed of the photo resist layer 32 and the glass substrate 31 be in a desired ratio, curved surfaces 36 having a desired depth and shape can be made.

The method for obtaining individual one dimensional focusing optical device 9B from the glass substrate 31 in which the curved surfaces 36 are formed is similar to the above described method.

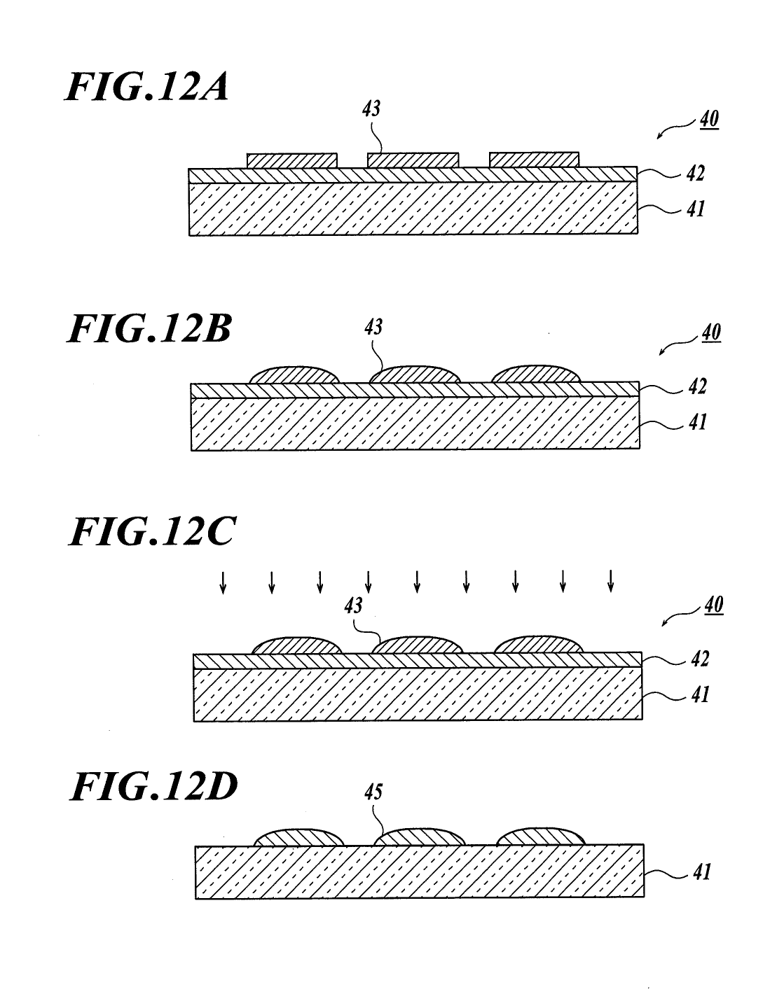

Next, the manufacturing method of the gray scale mask 34 will be described. FIGS. 12A to 12D are schematic views of the manufacturing method of the gray scale mask 34 using the photolithography processing method.

The gray scale mask 34 is manufactured by using the photolithography processing method which is described in FIGS. 11A to 11F.

First, a substrate 40 in which a partially permeable film 42 is formed on a glass substrate 41 and photo resist layers 43 which are extended in the depth direction in the drawing having a rectangular sectional shape are formed on the partially permeable film 42 is prepared (FIG. 12A). As for the glass substrate 41, a material having good etching resistance is to be used. Partially permeable film is a film which the light does not transmit completely and does not reflect completely. In particular, the partially permeable film is a thin metallic film, and for example, it is a chromium film, aluminum film or the like which is deposited to the thickness of a few nanometers to a few tens of nanometers.

Next, the substrate 40 is made to enter a constant temperature bath in which the temperature is maintained at the heat resistance temperature of the photo resist layer 43 or above. With respect to the photo resist layer 43 which is exposed to the heat resistance temperature or above, the cross section thereof deforms into a rounded shape by being dissolved and by the surface tension. After being cooled down, the shape of the cross section of the photo resist layer 43 is fixed to the rounded shape (see FIG. 12B).

Next, when anisotropic etching is carried out from the opposite side of the glass substrate 41 which is the surface normal direction of the partially permeable film 42, etching is to be started from the photo resist layer 43 and the partially permeable film 42 where the photo resist layer 43 is not loaded (FIG. 12C). When the photo resist layer 43 and the partially permeable film 42 where the photo resist layer 43 is not loaded is completely removed, the partially permeable film 42 itself is to be process into a shape where the shape of the photo resist layer 43 is copied (FIG. 12D). Because the transmittance distribution changes according to the thickness of the partially permeable film 42, the gray scale mask 34 functions as a gray scale mask. As described above, by selecting the type of the photo resist and the material of the partially permeable film 42 so that the etching speed ratio of the photo resist layer 43 and the partially permeable film 42 be a desired ratio, curved surfaces 45 can be manufactured so as to have a desired transmittance distribution.

### [Third Manufacturing Method]

The one dimensional focusing optical device 9B can be manufactured based on a silicon substrate by taking advantage of the characteristic of silicon by directly processing the one dimensional focusing optical device 9B by using the photolithography processing method where etching is mainly carried out.

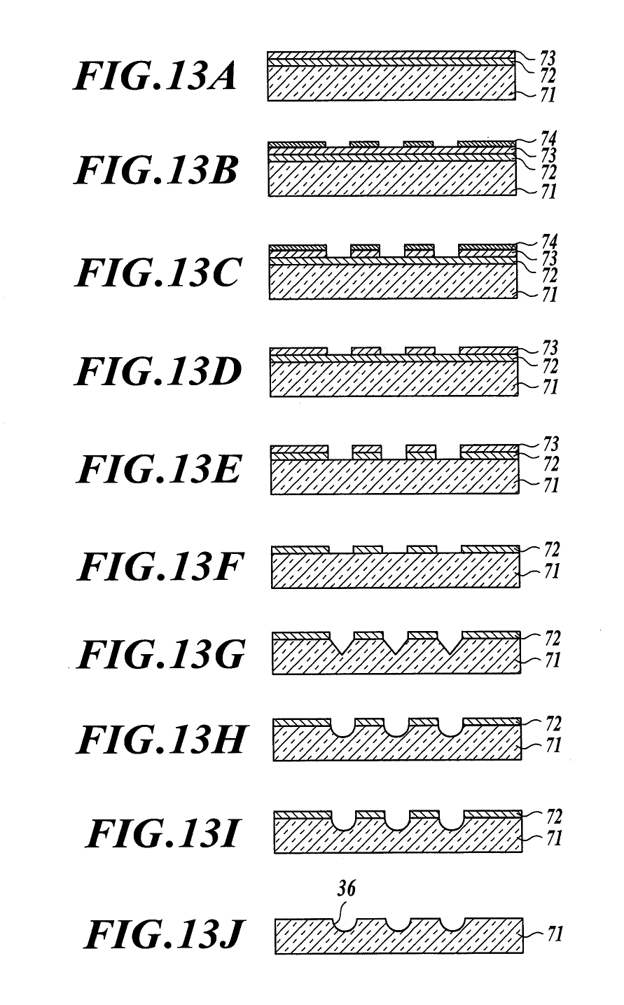

FIG. 13 is a schematic view of the photolithography processing method in which etching is mainly carried out. Hereinafter, the manufacturing method of the one dimensional focusing optical device 9B will be described by using FIGS. 13A to 13J.

First, a nitride film (Si₃N₄) 72 and a silicon oxide film (SiO₂) 73 are formed on the silicon substrate 71 in this order (see FIG. 13A). The nitride film 72 and the silicon oxide film 73 may be formed by carrying out the vacuum thin film coating method such as vapor deposition, spattering or the like using each of the materials. Further, in the case of the nitride film 72, the silicon may be made to react in a nitrogen atmosphere.

Next, a positive type photo resist is patterned on the silicon oxide film 73 (see FIG. 13B). The pattern 74 is formed at a portion excluding the parts where the curved surfaces 35 of circular-cylindrical surface which are described in the second manufacturing method are to be formed. In particular, a photo resist film is formed on the silicon oxide film 73 by using a spinner or a roll coater, and the pattern is printed on the photo resist film by irradiating ultraviolet rays using a mask and the photo resist film is developed by alkaline solution.

Next, patterning is carried out by carrying out etching to the silicon oxide film 73 by using the formed resist pattern 74 as a mask (see FIG. 13C). To carry out etching to the silicon oxide film 73, for example, ammonium fluoride solution is used.

Next, the resist pattern 74 is removed by using alkaline solution (se FIG. 13D).

Thereafter, patterning is carried out by carrying out etching to the nitride film 72 by using the silicon oxide film 73 which is patterned as a mask (see FIG. 13E). To carry out etching to the nitride film 72, heated phosphoric acid is used.

Next, the silicon oxide film 73 which is patterned is removed by using ammonium fluoride solution (see FIG. 13F).

Thereafter, etching is carried out to the silicon by using the pattern of the nitride film 72. In the etching of the silicon, a liquid mixture of nitric acid, fluorinated acid and acetic acid is used as an etchant.

Nitric acid reacts with water and nitrous acid (HNO₂) to generate nitrous acid and holes (h+), and the holes makes the silicon to be oxidized. A reaction where the oxidized SiO₂ dissolves by fluorinated acid occurs.

When the etching is started, the exposed surface of the silicon is a flat surface. However, because etching is not to be carried out to the parts where the patter of the nitride film 72 exist, the border between the exposed surface of the silicon and the pattern of the nitride film 72 is to be etched so that the cross section thereof be formed in an approximately rounded shape. By this process of etching, the shape of the etched cross section is to be determined according to the difference in ratio of nitric acid and fluorinated acid for the following reasons.

Nitrous acid which is generated by the reaction is accumulated at the part (for example, concaved part) having a shape which is difficult to be exposed to the etching solution, therefore, the reaction of generating the holes (h+) is facilitated. Thus, the etching speed at the part having a shape which is difficult to be exposed to the etching solution is to be relatively fast. This shows that the etching speed depends on the shape of the part targeted for etching.

Further, when there is more nitric acid, the part where fluorinated acid can reach easily, that is, the part having a shape which is easily exposed to the etching solution dissolves fast. However, dissolving of the part having a shape which is difficult to be exposed to the etching solution is not facilitated because nitrous acid is accumulated. Therefore, the part having a shape which is easily exposed to the etching solution is prone to be formed in a rounded shape.

In such way, the etching speed of silicon which is targeted for etching differs according to the shape thereof and depends of the ration of nitric acid and fluorinated acid.

According to the above shown etching process, for example, when the etchant is rich in fluorinated acid where fluorinated acid is included more comparing to nitric acid, the etching cross section is prone to form a V shape as shown in FIG. 13G. On the other hand, when the etchant is rich in nitric acid where nitric acid is included more comparing to fluorinated acid, the etching cross section is prone to form a rounded shape as shown in FIG. 13H. By taking advantage of such characteristics, by appropriately setting the ration of nitric acid and fluorinated acid, the arbitrary aspheric shape as shown in FIG. 13I, that is, the curved surfaces 36 having a desired depth and shape can be made.

Lastly, etching is carried out to the nitride film 72 by using a heated phosphoric acid (see FIG. 13J).

The method for obtaining individual one dimensional focusing optical device 9B from the silicon substrate 71 in which the curved surfaces 36 are formed is similar to the method as described above.

### [Fourth Manufacturing Method]

The one dimensional focusing optical device 9B can be manufactured based on a plate such as glass, silicon, semiconductor or SiO₂ by carrying out direct processing of continuous groove processing by rotating a dicing blade having a desired tip shape to carry out machining.

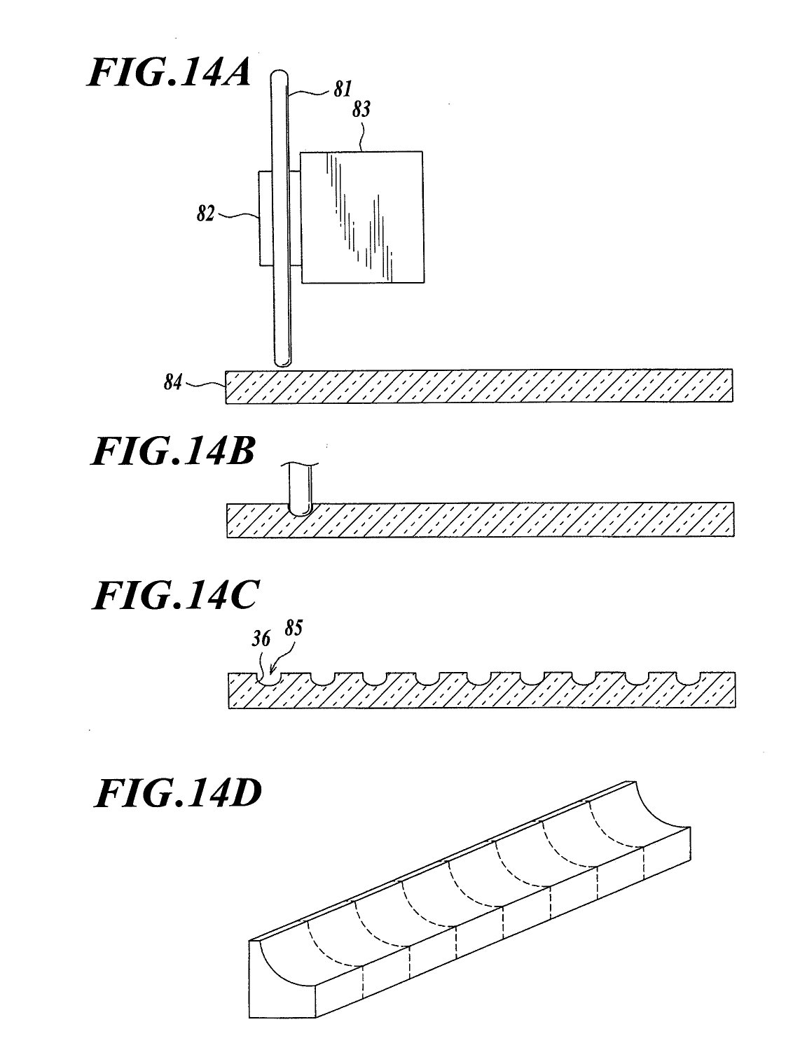

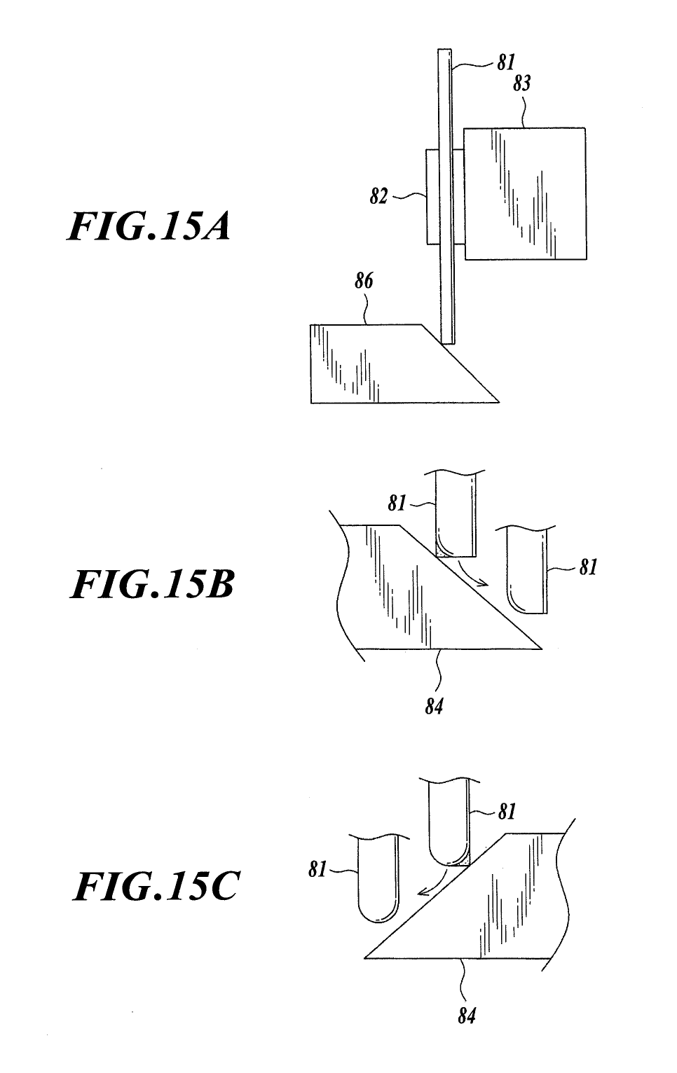

Hereinafter, the manufacturing method of the one dimensional focusing optical device 9B will be described by using FIGS. 14A to 14D and FIGS. 15A to 15C. FIGS. 14A to 14D are schematic views of a processing method using a dicing blade 81.

The dicing blade 81 is fixed to the rotation axis of the spindle motor 83 in the dicing saw by a flange 82 (see FIG. 14A).

The glass substrate 84 is fixed on the processing table (not shown in the drawing) of the dicing saw by using a two-sided adhesive film (not shown in the drawing). A triaxial automatic moving mechanism (not shown in the drawing) is provided at the processing table and is controlled by a controlling device (not shown in the drawing).

By using the above dicing saw, the dicing blade 81 is rotated at high speed to machine the surface of the glass substrate 84 to process the grooves 85 (see FIG. 14B). Not only the glass substrate, but also a semiconductor such as silicon, SiO₂ and the like can be targeted for machining. The dicing blade 81 in which the cross section shape of the tip thereof is a shape where two of the curved surfaces 36 which are desired are aligned is to be used. The controlling device controls the tip of the dicing blade 81 so as to form the grooves 85 corresponding to the shape of the curved surfaces 36 on the surface of the glass substrate 84.

The grooves 85 corresponding to the curved surfaces 36 are formed in plurality having an interval which is decided according to the size of the one dimensional focusing optical device 9B between each other (see FIG. 14C). The reflection film is formed on each curved surface 36 and the glass substrate 84 is cut in the shape of the one dimensional focusing optical device 9B by using the dicing saw (not shown in the drawing). Here, as shown in FIG. 14D, the reflection film may be formed after the glass substrate 84 is cut in a shape such as where the one dimensional focusing optical devices 9B are continuously aligned in one direction. In such way, the reflection film can be prevented from being peeled off from the curved surface 36 at the time of cutting.

The dicing blade 81 is to be manufactured as follows. FIGS. 15A to 15C are schematic views showing a processing method of the tip of the dicing blade 81.

The shape of the tip of the dicing blade 81 is to be processed by using a dresser 86 (see FIG. 15A). Normally, the dicing blade 81 is made by an electrocasting which carries out plating while depositing abrasive grains on electrode. Therefore, the cross section thereof has a square shape. Thus, the tip of the dicing blade 81 is grinded into a half sphere shape by making the tip of the dicing blade 81 contact the dressing surface of one side of the dresser 86 so as to draw a circle (see FIG. 15B). Next, by grinding the other side in similar way (see FIG. 15C), the dicing blade 81 in which the cross section of the tip thereof has a desired curved surface can be obtained.

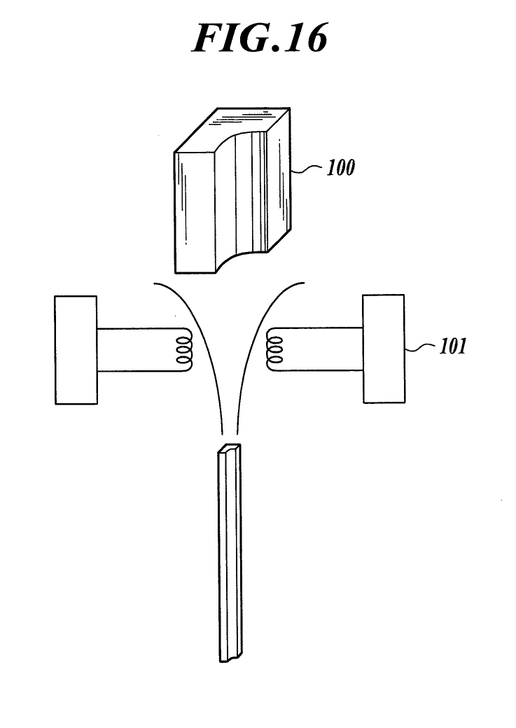

Other than the above described manufacturing methods of the one dimensional focusing optical device 9B, JP 2003-337245 discloses a method of manufacturing a substrate for optical fiber allay by a drawing process. However, the base material may be in a shape having a plurality of grooves formed in parallel to each other and such base material can be drawn to form a product having a shape similar to the shape shown in FIG. 10A. Because the optical device of the present invention is formed in a circular-cylindrical surface shape, such manufacturing method is possible. Further, a product having a shape similar to that as shown in FIG. 14D can be manufactured by drawing a base material having similar shape as the one dimensional focusing optical device 9B shown in FIG. 3. In particular, for example, a product having a shape similar to that shown in FIG. 14D can be manufactured by hating a base material (for example, a glass base material) 100 having a shape similar to that of the one dimensional focusing optical device 9B, when the one dimensional focusing optical device 9B is seen from the axis direction of the cylindrically curved surface including the reflection surface 13 (extending direction of the one dimensional focusing optical device 9B), by a heater 101, stretching the base material 100 in the axis direction and cutting the stretched material in a predetermined length by a cutter, as shown in FIG. 16. When a base material having a shape similar to that of the one dimensional focusing optical device 9B is to be used for drawing, differently from the case where a cylindrical base material is used for drawing to obtained the curved surfaces 36 (reflection surfaces 13) from the inner circumference thereof, cutting of the stretched material along the stretched direction can be omitted. Therefore, the manufacturing cost of the one dimensional focusing optical devices 9B can be reduced.

Here, in the above description, it is assumed that an optical material is used as a material of the one dimensional optical device. However, because the one dimensional optical device is a surface reflection optical device, a non-transparent non-optical material such as metal, metal alloy, ceramic or the like may be used.

In the above embodiments, it is assumed that the active layer 51 is near the slider 10. However, by providing a holding unit for holding the light source 9A in between the light source 9A and the slider 10, the distance from the slider 10 to the active layer 51 can be made to be relatively long.

By providing the above holding unit, the distance from the light source 9A to the planar waveguide can be relatively long. Therefore, the one dimensional focusing optical device 9B can be large and the manufacturing of the one dimensional focusing optical device 9B can be easier.

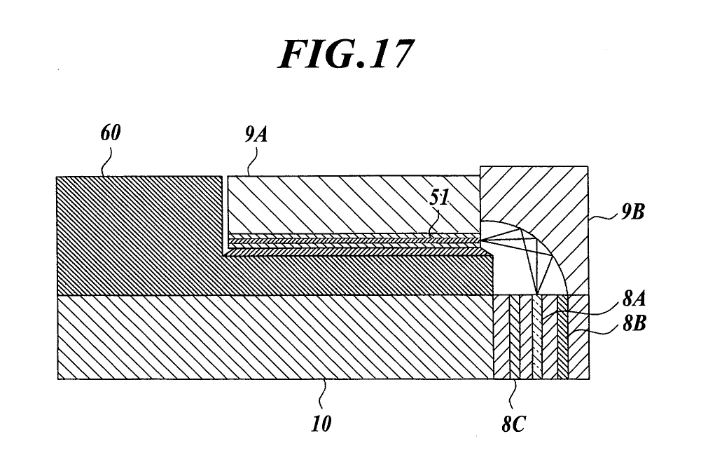

FIG. 17 is a schematic view in which a unit substrate 60 is provided as a holding unit for holding the light source 9A. It is preferred that the unit substrate 60 is manufactured with a metal having high heat dissipation or a conductive ceramic. The light source 9A and the unit substrate 60 are adhered to each other by soldering. It is preferred that the unit substrate 60 and the slider 10 are adhered to each other by an adhesive having high heat dissipation, solvent welding or the like. On one surface of the unit substrate 60, a bonding pad to be used when wiring the light source 9A and the power supply unit (not shown in the drawing) can be provided.

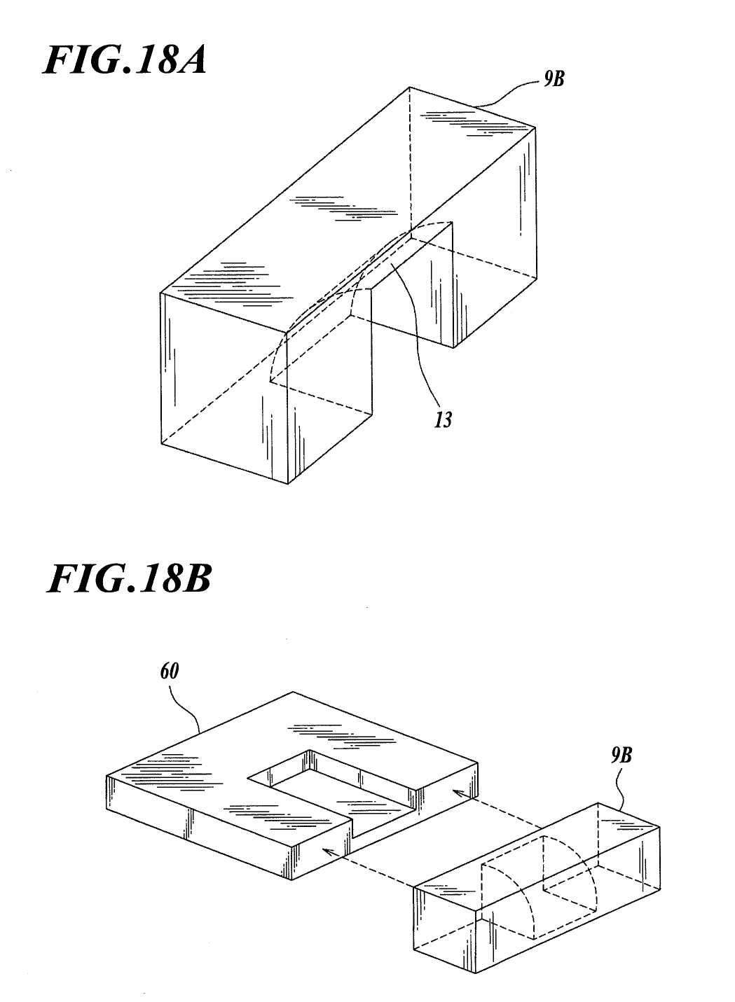

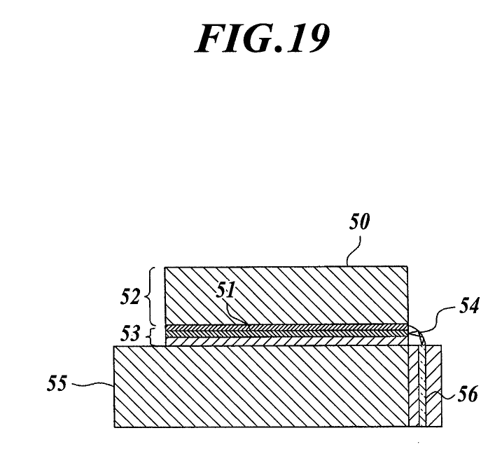

Moreover, the one dimensional focusing optical device 9B may have a shape in which the reflection surface 13 is formed by grading a part of the rectangular solid. FIGS. 18A and 18B are schematic views of the one dimensional focusing optical device 9B in which the reflection surface 13 of a cylindrical surface is formed in the rectangular solid. FIG. 18A is a schematic view of the one dimensional focusing optical device 9B in which the reflection surface 13 of a circular-cylindrical surface is formed in the rectangular solid. In such way, by forming the reflection surface 13 at a part of the rectangular solid, handling can be easier and the assembling adjustment can be carried out easily. FIG. 18B is a schematic view showing the bonding method of the one dimensional focusing optical device 9B and the unit substrate 60. The one dimensional focusing optical device 9B is driven against and fixed on one surface of the unit substrate 60 which corresponds to the light exit surface.

As described above, according to the embodiment, an optical device in which the amount of light loss is small and which has a biasing function in which positional adjustment can be carried out easily can be provided. This is realized because the above optical device includes a concave surface formed of a part of a cylindrically curved surface and does not have incident surface and exit surface because the concave surface is the surface reflection face, and because the focused light is linear due to the focusing function of the optical device being one dimensional and the strict positional adjustment of the light on the incident end surface of the planar waveguide which couples the light only needs to be carried out in one dimensional direction. Further, because the reflection surface of a concave surface which is formed of a part of a cylindrically curved surface is formed at a part of the edge lines of the rod-like rectangular solid, an optical device which can be manufactured easily even it is a very small mirror can be provided.

Moreover, according to another embodiment, because the concave surface is formed of a part of a circular-cylindrically curved surface, light can be coupled to the planar waveguide in the focusing direction with a small aberration. Therefore, the coupling efficiency can be improved.

Further, according to another embodiment, because the concave surface is formed of a part of an oval-cylindrically curved surface, light can be coupled with the planar waveguide in the focusing direction with no aberration. Therefore, the coupling efficiency can be improved drastically.

Furthermore, according to another embodiment, because the reflection film is formed on the concave surface, light from the light source can be used efficiently to be coupled with the planar waveguide.

Moreover, according to another embodiment, the optical devices are manufactured by the manufacturing method including the process of transferring the concave surfaces by a mold having the reversed shape of the concave surfaces. Therefore, the optical devices having the same concave surfaces can be manufactured in large amount at low cost.

Further, according to another embodiment, the optical devices are manufactured by the manufacturing method including the process of forming the concave surfaces in a groove by directly processing a plate-like substrate. Therefore, the curved surfaces can be made with high accuracy and the coupling efficiency of light with the planar waveguide can be improved drastically.

Furthermore, according to another embodiment, the direct processing includes a processing of dicing and a processing of etching. Therefore, in the case of dicing, a desired surface shape can be obtained according to the shape of the dicing blade, and a plurality of curved surfaces can be made continuously as a groove and further, the optical devices can be manufactured by using materials having any kinds of material properties. In the case of etching, the optical devices can be manufactured with good reproducibility and at low cost due to being used in the semiconductor integrated circuit manufacturing process. Further, a plurality of optical devices can be manufactured in a bulk. Furthermore, because a masking process is used, marks or the like to be used as signs for cutting positions, adjustment positions and the like can be processed at the same time.

Moreover, according to another embodiment, the above described manufacturing method of optical devices includes the drawing process in which the base material having a shape similar to that of the optical device, when the optical device is seen from the direction along the axis direction of the cylindrically curved surface, is drawn. Therefore, differently from the case where a base material of cylindrical shape is drawn and the curved surfaces (reflection surface) are obtained from the inner circumference thereof, the cutting of the stretched member along the stretched direction can be omitted and the manufacturing cost of the optical devices can be reduced.

Further, according to another embodiment, because the optical devices are manufactured in large number by the above described manufacturing method, the optical devices can be manufactured with good reproducibility regardless of materials and with high accuracy at low cost.

Furthermore, according to another embodiment, an optically assisted magnetic recording head including a light source, a waveguide which irradiates the light emitted from the light source to a magnetic recording medium and a slider in which the light source and the waveguide are mounted, and the positional adjustment can be carried out easily and the amount of light loss can be made small by coupling the light emitted from the light source with the waveguide by using the optical device. Therefore, an optically assisted magnetic recording head in which power consumption is low and assembling is easy can be provided.

Moreover, according to another embodiment, because a holding unit for holding the light source is provided in between the light source and the slider, the distance from the light source to the planar waveguide can be relatively long. Therefore, the entire optical device can be made large and manufacturing of the optical device can be easier.

Further, according to another embodiment, because the holding unit further holds the optical device, accuracy of the positions of the light source and the optical device can be maintained.

Furthermore, according to another embodiment, by a magnetic recorder mounting the optically assisted magnetic recording head, a magnetic recorder in which power consumption is low and which can be manufactured easily can be provided.

The entire disclosure of Japanese Patent Application No. 2010-171449 filed on Jul. 30, 2010 and Japanese Patent Application No. 2010-264704 filed on Nov. 29, 2010 including descriptions, claims, drawings, and abstracts are incorporated herein by reference in its entirety.

What is claimed is:

1. An optical device, comprising:
a concave surface formed of a part of a cylindrically curved surface, wherein
the concave surface is a reflection surface.

2. The optical device of claim 1, wherein the concave surface is formed of a part of a circular-cylindrically curved surface.

3. The optical device of claim 1, wherein the concave surface is formed of a part of an approximately oval-cylindrically curved surface.

4. The optical device of claim 1, wherein a reflection film is formed on the concave surface.

5. A manufacturing method of the optical device of claim 1, wherein the concave surface is transferred by a mold having a reverse shape of the concave surface.

6. A manufacturing method of the optical device of claim 1, wherein the optical device is formed based on a plate-like substrate, and
the concave surface is formed by directly processing the substrate.

7. The manufacturing method of claim 6, wherein the directly processing includes a dicing or an etching.

8. A manufacturing method of the optical device of claim 1, wherein the manufacturing method includes a drawing of a base material in an axis direction, the base material having a shape similar to a shape of the optical device when the optical device is seen from a direction along the axis direction of the cylindrically curved surface.

9. An optical device which is manufactured by the manufacturing method of claim 5.

10. An optical device which is manufactured by the manufacturing method of claim 6.

11. An optical device which is manufactured by the manufacturing method of claim 8.

12. An optically assisted magnetic recording head, comprising:
a light source;
a waveguide which irradiates light emitted from the light source on a magnetic recording medium; and
a slider which mounts the light source and the waveguide, wherein
the light emitted from the light source is reflected and coupled with the waveguide by using the optical device of claim 1.

13. The optically assisted magnetic recording head of claim 12, further comprising a holding unit to hold the light source, the holding unit being disposed between the light source and the slider.

14. The optically assisted magnetic recording head of claim 13, wherein the holding unit further holds the optical device.

15. A magnetic recorder in which the optically assisted magnetic recording head of claim 12 is mounted.
